(19) United States
(12) Patent Application Publication
(10) Pub. No.: US 2022/0165107 A1
(43) Pub. Date: May 26, 2022

(54) AUTOMATED MASK WEARING RECOGNITION REMINDER AND UNLOCKING SYSTEM FOR AN ENTRANCEWAY

(71) Applicant: Georges Raymond BROW, Georgetown Royalty (CA)

(72) Inventor: Georges Raymond BROW, Georgetown Royalty (CA)

(21) Appl. No.: 17/534,591

(22) Filed: Nov. 24, 2021

(30) Foreign Application Priority Data
Nov. 26, 2020 (CA) 3101854
Dec. 15, 2020 (CA) 3102989

(51) Int. Cl. G07C 9/00; G06V 40/20; G06V 40/10; G06V 40/16

(52) U.S. Cl. CPC G07C 9/00563; G06V 40/20; G07C 2209/62; G06V 40/171; G06V 40/15

(57) ABSTRACT

The present invention relates to a mask wearing reminder system having a facial recognition device mounted proximate to an entranceway. When approaching the entranceway the visitor must first utilize facial recognition confirming the traveller is wearing a mask to gain entry or exit through the entranceway. When the facial recognition device is utilized it transmits a signal to a processor which then deactivates temporarily a motion/presence detector scanning an area immediately adjacent or close to the entranceway and the door locking device and thus permits entry or exit for the visitor. If facial recognition has not been utilized, the proximity detector will remain armed, and the door shall remain locked.

### FIELD OF THE INVENTION

The present invention relates generally to an automated mask wearing recognition reminder and unlocking system for an entranceway, and more particularly, to an automated mask wearing recognition reminder and unlocking system having a facial recognition device mounted proximate to the entranceway that, when utilized and it is determined a visitor is wearing a mask, deactivates temporarily a motion/presence detector scanning an area immediately adjacent or close to the entranceway and permits entry (or exit) for the visitor. If facial recognition determines that the visitor is not wearing a mask, the motion/presence detector will remain armed, and the door shall remain locked.

### DESCRIPTION OF THE PRIOR ART

Many diseases, such as hepatitis, have been found to be transmittable due to a failure of people to wash their hands. In fact, certain public health laws require those in, for example, the food distribution field to wash their hands each time they exit these facilities before they resume their duties. In areas such as hospitals or labs, the spread of germs and contagions is a serious health concern. For this reason, many such facilities post visual signs which are intended to remind a person to wash their hands before entry/exit, but such signs can be easily ignored, and thus stronger warning systems are required if such spread of disease is to be checked or inhibited. While signs may be innocuous means of warning the public of the need to wash their hands, with a view to reducing the spread of germs and contagions, stronger warning means that provide audible or visual alerts should be used in certain public facilities to provide these reminders, such as tor employees of a restaurant, hospitals, food processing or research facilities, or the like.

Furthermore, with the spread of COVID-19, there exists many situations in society presently where use of masks are mandatory or strongly encouraged to try to limit the spread of this virus. It therefore would be beneficial for a system to exist where entry of visitors into certain areas could be safely and effectively controlled to require the use of such masks before gaining entry.

Accordingly, there is need for an automated mask wearing recognition reminder and unlocking system for an entranceway, and more particularly, to an automated mask wearing recognition reminder and unlocking system having a facial recognition device mounted proximate to an entranceway that, when utilized, deactivates temporarily a motion/presence detector scanning an area immediately adjacent or close to the entranceway and permits entry or exit for the visitor. If facial recognition determines that the visitor is not wearing a mask, the motion/presence detector will remain armed, and the door shall remain locked, the proximity detector will remain armed, and the door shall remain locked. To this end, the present invention effectively addresses this need.

### SUMMARY OF THE INVENTION

A general object and advantage of the present invention is to provide an improved automated mask wearing recognition reminder and unlocking system for an entranceway having a facial recognition device mounted proximate to the entranceway that, when utilized and it is determined a visitor is wearing a mask, deactivates temporarily a motion/presence detector scanning an area immediately adjacent or close to the entranceway and permits entry (or exit) for the visitor.

A still further object and advantage of the present invention is to provide an improved automated mask wearing recognition reminder and unlocking system for an entranceway wherein, if facial recognition determines that the visitor is not wearing a mask, the motion/presence detector will remain armed, and the door shall remain locked.

A still further object and advantage of the present invention is to provide an improved automated mask wearing recognition reminder and unlocking system for an entranceway having a message conveying device mounted proximate to the entranceway and being electrically coupled and in electronic communication with the facial recognition device, for providing an access allowed signal when the facial recognition device determines that a person is wearing a mask, and denying entry when the person is determined to not be wearing a mask.

According to one aspect of the present invention, there is provided an automated mask wearing recognition system for an entranceway comprising a facial recognition device mounted proximate to the entranceway; a motion/presence detector mounted proximate to the entranceway and constructed and arranged for detecting an approach of a visitor to the entranceway; a processor mounted proximate to the entranceway and being electrically coupled to, and in electronic communication with, the facial recognition device and the motion/presence detector; and message conveying means mounted proximate to the entranceway and being electrically coupled and in electronic communication with the facial recognition device, the message conveying means providing an access allowed signal when the facial recognition device determines that a person is wearing a mask, and denies entry when the person is determined to not be wearing a mask.

According to another aspect of the present invention, there is provided a method for manufacturing an automated mask wearing recognition system for an entranceway comprising the steps of providing a facial recognition device mounted proximate to the entranceway; providing a motion/presence detector mounted proximate to the entranceway and constructed and arranged for detecting an approach of a visitor to the entranceway; providing a processor mounted proximate to the entranceway and being electrically coupled Lo, and in electronic communication with, the facial recognition device and the motion/presence detector; and providing message conveying means mounted proximate to the entranceway and being electrically coupled and in electronic communication with the facial recognition device, the message conveying means providing an access allowed signal when the facial recognition device determines that a person is wearing a mask, and denies entry when the person is determined Lo not be wearing a mask.

According to another aspect of the present invention, there is provided a method for manufacturing an automated mask wearing recognition system for an entranceway comprising the steps of providing product dispensing means constructed and arranged to be mounted proximate to the entranceway; providing a facial recognition device constructed and arranged to be mounted proximate to the entranceway; providing a motion/presence detector constructed and arranged to be mounted proximate to the entranceway and constructed and arranged for detecting an approach of a visitor to the entranceway; providing a processor constructed and arranged to be mounted proximate to the entranceway and in electronic communication with the facial recognition device, the product dispensing means and the motion/presence detector; and providing message conveying means mounted proximate to the entranceway and in electronic communication with the processor, the message conveying means providing an access allowed signal when the facial recognition device determines that a person is wearing a mask, and denies entry when the person is determined to not be wearing a mask.

According to another aspect of the present invention, there is provided an automated mask wearing recognition system for an entranceway comprising product dispensing means mounted proximate to the entranceway; a facial recognition device mounted proximate to the entranceway; a motion/presence detector mounted proximate to the entranceway and constructed and arranged for detecting an approach of a visitor to the entranceway; a processor mounted proximate to the entranceway and in electronic communication with the facial recognition device, the product dispensing means and the motion/presence detector; and message conveying means mounted proximate to the entranceway and in electronic communication with the processor, the message conveying means providing an access allowed signal when the facial recognition device determines that a person is wearing a mask, and denies entry when the person is determined to not be wearing a mask.

### BRIEF DESCRIPTION OF THE DRAWINGS

A preferred embodiment of the present invention is described below with reference to the accompanying drawing, in which:

FIG. 1 illustrates a front view of the automated mask wearing recognition reminder and unlocking system for an entranceway of the present invention.

### DESCRIPTION OF THE PREFERRED EMBODIMENT

The present invention relates to an automated mask wearing recognition reminder and unlocking system for an entranceway, and more particularly, to an automated mask wearing recognition reminder and unlocking system having a facial recognition device mounted proximate to an entranceway that, when utilized, deactivates temporarily a motion/presence detector scanning an area immediately adjacent or close to the entranceway and permits entry or exit for the visitor. If facial recognition determines that the visitor is not wearing a mask, the proximity detector will remain armed, and the door shall remain locked, the proximity detector will remain armed, and the door shall remain locked.

It will be understood that the automated mask wearing recognition reminder and unlocking system of the present invention (and all components thereof) is, in an exemplary embodiment, in electronic communication with the Internet and/or other communications systems (such as through a network) via Wi-Fi, radio, Bluetooth™, for example, through means of an accessible network and processor 7 interconnected with the system.

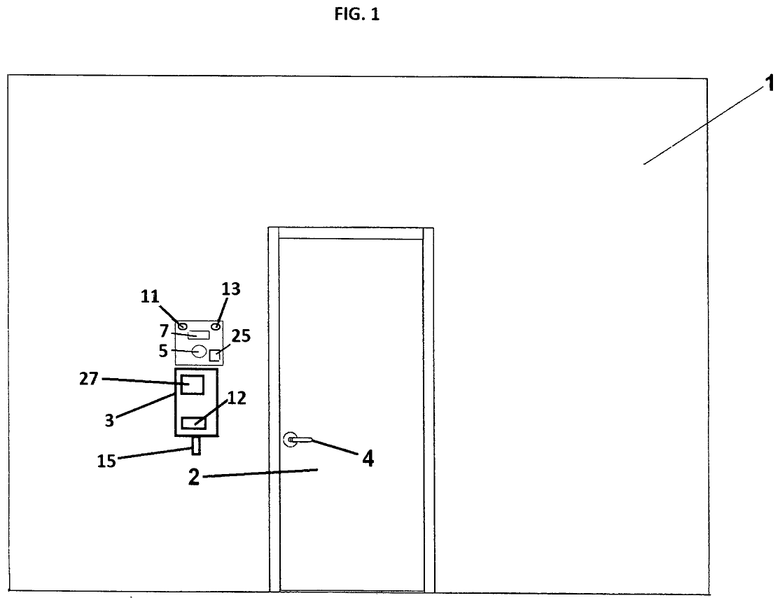

With reference now to FIG. 1, the automated mask wearing recognition reminder and unlocking system of the present invention, generally designated by the reference numeral 1, will now be described. In one embodiment, the system is electrically coupled to a primary power supply (not shown), preferably by hardwiring an electrical supply to components of the system. In an alternative embodiment, an alternate power source, such as battery power, could also be utilized. The automated mask wearing recognition reminder and unlocking system 1 generally comprises a disinfectant dispenser 3 that is mounted proximate to the entranceway 2. In one embodiment, the disinfectant dispenser 3 is mounted on a wall proximate and adjacent to the entranceway 2, though it will be readily understood that variations as to the placement of the disinfectant dispenser 3 are possible, as would be readily understood by one skilled in the art. For example, the disinfectant dispenser 3 could be mounted on another component, such as a tower, in close proximity to the entranceway 2. It will also be understood that disinfectant dispenser 3 is, preferably, arranged to be mounted on the outside or inside of a building, near an exterior doorway, or located inside the building's vestibule, and that a second, or indeed a plurality of disinfectant dispensers may be utilized to compel hand sanitization prior to exit or entry through the entranceway 2.

A motion/presence detector 5 is mounted on the disinfectant dispenser 3 and is adapted for detecting an approach of a visitor to the entranceway 2, it being understood that the motion/presence detector 5 can be conventional in nature, and that variations as to the placement of the motion/presence detector 5 are possible. Such a motion/presence detector 5 will preferably have a camera (not shown) in association therewith, whereby approaching visitors can be visually scanned for compliance with wearing a mask before entering the entranceway 1. It will also be understood that a proximity detector could also be utilized, if desired. In one embodiment, a processor 7 is housed within (or in proximity to) the disinfectant dispenser 3 it being understood that the processor 7 is in electronic communication with other components of the system, such as the motion/presence detector 5, message conveying apparatus 25, access allowed emitter 11 and access denied emitter 13, thermal temperature sensor 27, as hereinafter described, and that these components are also in with electronic communication with the Internet and/or other communications systems.

In a preferred embodiment, the automated mask wearing recognition system for an entranceway 1 can have a thermal temperature sensor 27 (as seen in FIG. 1) in electronic communication with the processor 7 and other components of the system, for monitoring a temperature of an approaching visitor, whereby those with an elevated temperature will be restricted access through the entranceway, and users of a set allowable temperature, will be permitted entry through the entranceway. This set allowable temperature can, of course be variably set, and it will be understood that such temperature sensor 27 could be positioned at numerous locations proximate to the entranceway, or on other components of the system. Should a visitor exceed this set allowable temperature, entry through the doorway can be denied.

A data storage device 12 can be mounted on the disinfectant dispenser 3, or at various other locations proximate to the system 1, for storing events and history relating to use of the system 1, it being understood that variations to the type of information collected and stored by the data storage device 12 are possible. Examples of such information that could be collected and stored in the data storage device could include (but is not limited to) the number of people entering and exiting the building, the number of persons denied entry, the number of people and/or percentage of people who used the disinfectant dispenser 3, and malfunction alerts, as well as tracking entry and exits of visitors to ensure legal capacity limits as to visitor limits within a space are maintained. In an alternative embodiment, the data storage device can also store a “low battery” warning that can be issued through the message conveying apparatus 25, when a battery powered power source is utilized and power is low, and can also be used to collect and store marketing information relating to the visitors passing or exiting through the entranceway 2. Further information that can be collected and stored can relate to (but is not limited to) the collection of data when situations arise where visitors are required to answer certain questions to gain entry.

In operation, when approaching the entranceway 2 to facility, in one embodiment, the visitor must first utilize disinfectant dispenser 3 by means of disinfectant dispensed from spout 15 to gain unalarmed entry to or exit from the facility through the entranceway 2. At the same time, thermal temperature sensor 27 scans the visitor to assure compliance with the set allowable temperature, and the motion/presence detector 5 scans the visitor to assure compliance with wearing a mask before entering the entranceway 1.

If the visitor is in compliance with of these objectives and standards (or achieving a pre-set standard for gaining entry) the components of the system transmit signals to a processor 7, which then deactivates temporarily the motion/presence detector 5 scanning an area immediately adjacent or close to the entranceway 2, and thus permits entry or exit for the visitor. At the same time, processor 7 activates access allowed emitter 11 to provide a visual indication to the visitor that passage is permitted, and, simultaneously also activates an access allowed audio tone to be played through message conveying apparatus 25.

However, it will be understood that if the disinfectant dispenser 3 has not been utilized, or if thermal temperature sensor 27 and the motion/presence detector 5 determines a visitor is not in compliance with the set allowable temperature, or is not wearing a mask, respectively, then no signal from the system 1 will be transmitted to the processor 7, and the entranceway 2 will remain in a locked (closed) position. In this scenario, the motion/presence detector 5 issues an access denied audio tone to be played through message conveying apparatus 25, and, can also simultaneously activate the access denied emitter 13 to provide a visual indication to the visitor that passage is not permitted. The message conveying apparatus 25 can also be used to convey, in one embodiment, relevant pre-recorded announcements, that can be chosen or required as needed.

In one embodiment, the visual indication that is given to the visitor to indicate that passage is permitted can be a signal, visual or otherwise, (such as a “green” light), and the visual indication that is given to the visitor to indicate that passage is not permitted is another form of signal (such as, for example only, a “red light”), though it will, of course, be understood that numerous variations as to this can be effected. As seen in FIG. 1, the visitor could utilize handle 4 on the door to gain entry or exit, or, alternatively, the entranceway 2 could contain no door at all.

In a still further embodiment, it will be understood that access through the entranceway 2 can also be accomplished by means of a swipe card (now shown) for those deemed to have appropriate clearance for the system 1. Alternatively, the mask recognition system could also be bypassed by using a code entered through a keypad, a RFID/NFC key fob/swipe cards (as noted) or a code sent over the Internet/network communications system.

It will be appreciated by those skilled in the art that the processor 7 is, preferably, in electronic communication with the disinfectant dispenser 3, and other components of the system, and can communicate with these through electromagnetic signals, or a combination thereof, as is conventionally known. Tt will also be appreciated by those skilled in the art that the electromagnetic signals can include infra-red, RF, or any other electromagnetic signal, as are well known in the art. Alternatively, the connection between these components could also be hard wired.

In a further embodiment, the processor 7 may also issue an audible message to individuals who are attempting to enter (or exit), and who have not utilized the disinfectant dispenser 3, or are not wearing a mask when approaching the entranceway 1, through the playing of a recorded audio message or reminder (such as, “Soap and Rinse your hands”, “Please place a mask over your face”, or “Please sanitize your hands to gain entry to this building”) through the message conveying apparatus 25, it being understood that variations as to the type of message conveyed are possible. It will, of course, be understood that multiple reminders could be effected, if the processor is so programmed. It will also be understood that either of the access allowed signal and access denied signal can be displayed substantially simultaneously with an issuance of a respective one of the access allowed audio tone and the access denied audio tone.

It will also be understood that such reminder messages can also be conveyed in the form of a visual reminder, such as through use of an LED sign (not shown), or other types of sounds that are emitted for the user to hear, it being understood that variations to these conveyed messages are possible.

In a still further embodiment, when supplies are low in the disinfectant dispenser 3, the signal emitter (not shown) from the soap/disinfectant dispenser 3 transmits a signal to the processor 7 to activate the low supply (or low soap) warning to be played through message conveying apparatus 25. In much the same manner, when battery power for the system is low, the processor 7 activates the low battery warning to be played through message conveying apparatus 25 when this occurs.

In a further embodiment of the present invention, events, data and information regarding the system 1 of the present invention (contained in data storage device 12) can be accessed via the internet or over an inter-connected network, remotely or on-site. It will be understood that through such interconnection, actions, settings or overview of the system 1 can be observed or changed via the internet or the inter-connected network. It will also be understood that these can also be changed manually on site by the operator. Preferably, components of the system may, if desired, also have their own web address, through which an operator will have security access to access any collected data from the data storage device 12.

In a further embodiment, the present invention may be equipped with an anti-vandalism feature (not shown) which is embedded in the disinfectant dispenser 3, or other component of the system, and which sends out a distress signal, via the processor 7, through wireless transmission or through other means previously described herein, to a remote operator advising of the situation.

In a still further embodiment of the present invention, the disinfectant dispenser 3 or other components of the system 1 can be configured for radio-frequency identification (RFID), or card reader information, whereby a visitor approaching the doorway could utilize a tag card, or swipe card, to temporarily deactivate the motion/presence detector 5 scanning an area immediately adjacent or close to the entranceway 2, and thus permits entry or exit for the visitor.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. An automated mask wearing recognition system for an entranceway comprising:
a facial recognition device mounted proximate to the entranceway;
a motion/presence detector mounted proximate to the entranceway and constructed and arranged for detecting an approach of a visitor to the entranceway;
a processor mounted proximate to the entranceway and being electrically coupled to; and in electronic communication with, the facial recognition device and the motion/presence detector; and
message conveying means mounted proximate to the entranceway and being electrically coupled and in electronic communication with the facial recognition device, the message conveying means providing an access allowed signal when the facial recognition device determines that a person is wearing a mask, and denies entry when the person is determined to not be wearing a mask.

2. The system of claim 1, wherein the system is constructed and arranged for connection to a power source.

3. The system of claim 1, wherein the system is adapted for displaying an access allowed signal via the message conveying means to provide an indication to the visitor that passage is permitted or an access denied signal on the message conveying means to provide an indication to the visitor that passage is not permitted.

4. The system of claim 2, further comprising an Internet/network connection in electronic communication with the processor, the facial recognition device and the motion/presence detector, whereby low supply warnings/low battery warnings, settings and events for the system can be retrieved from the processor and observed or changed on site or via the Internet/network connection remotely.

5. The system of claim 1, further comprising a thermal temperature sensor in electronic communication with the processor, wherein, when the thermal temperature sensor determines the person approaching the entranceway is not in compliance with a set allowable temperature for the system, the entranceway will remain in a closed position.

6. The system of claim 1, wherein the system further comprises product dispensing means mounted proximate to the entranceway.

7. The system of claim 1, wherein the system is in electronic communication with Internet or other communications systems via Wi-Fi, radio or Bluetooth™ entry when the person is determined to not be wearing a mask.

10. The method of claim 9, further comprising the step of providing a thermal temperature sensor in electronic communication with the processor, wherein, when the thermal temperature sensor determines the person approaching the entranceway is not in compliance with a set allowable temperature for the system, the entranceway will remain in a closed position.

11. The method of claim 9, further comprising the step of enabling the system to be in electronic communication with Internet or other communications systems via Wi-Fi, radio or Bluetooth™.

12. The method of claim 9, further comprising the step of permitting access through the entranceway through use of a code entered through a keypad, an authorized swipe card, an RFID/NFC key fob or a code sent over the Internet or the other communications systems.

13. The method of claim 9, further comprising the step of providing product dispensing means mounted proximate to the entranceway.

8. The system of claim 1, wherein access through the entranceway is effected through use of a code entered through a keypad, an authorized swipe card, an RFID/NFC key fob or a code sent over the Internet or the other communications systems.

9. A method for manufacturing an automated mask wearing recognition system for an entranceway comprising the steps of:
providing a facial recognition device mounted proximate to the entranceway;
providing a motion/presence detector mounted proximate to the entranceway and constructed and arranged for detecting an approach of a visitor to the entranceway;
providing a processor mounted proximate to the entranceway and being electrically coupled to, and in electronic communication with, the facial recognition device and the motion/presence detector; and
providing message conveying means mounted proximate to the entranceway and being electrically coupled and in electronic communication with the facial recognition device, the message conveying means providing an access allowed signal when the facial recognition device determines that a person is wearing a mask, and denies
